(19) United States
(12) Patent Application Publication
(10) Pub. No.: US 2010/0192402 A1
(43) Pub. Date: Aug. 5, 2010

(54) METHOD OF DRYING PRINTED MATERIAL AND APPARATUS THEREFOR

(75) Inventors: Yasuo Yamaguchi, Kanagawa (JP); Kentaro Asakura, Tokyo (JP); Yuji Akiduki, Saitama (JP); Toshiaki Yamaguchi, Tokyo (JP)

Correspondence Address: GREENBLUM & BERNSTEIN, P.L.C., 1950 ROLAND CLARKE PLACE, RESTON, VA, 20191, US

(73) Assignee: DAIDO SANGYO CO., LTD., Saitama (JP)

(21) Appl. No.: 12/667,958

(22) PCT Filed: Jul. 23, 2007
(86) PCT No.: PCT/JP2007/064423

§ 371 Date: Jan. 6, 2010

(51) Int. Cl. F26B 3/02; F26B 21/06

(52) U.S. Cl. 34/443; 34/191

(57) ABSTRACT

To carry out drying of printing ink with the use of Nano sized high-temperature dryness steam. Nano sized high-temperature dryness steam being clustered on Nano oder is generated and jetted to the print side of printed material so that the Nano sized high-temperature dryness steam imparts intramolecular vibrational energy to ink of the print side. Consequently, the Nano sized high-temperature dryness steam being clustered on Nano oder not only passes through fiber pores in the printed material but also collides with the ink of the print side. The Nano sized high-temperature dryness steam having collided with the ink of the print side imparts thermally excited energy as intramolecular vibrational energy to the ink containing polar molecules. The ink is dried by the intramolecular energy.

### TECHNICAL FIELD

The present invention relates to a printed material drying method and a printed material drying apparatus, which can efficiently dry printing ink on printed sides of printed materials to avoid adhesion of the printed materials with each other.

### BACKGROUND ART

When printing is performed on a print side of a printed material by using ink, it is required to dry the printed ink fixed on the printed materials quickly for preventing adhesion of the printed materials with each other by the ink fixed on the print side.

There has been no formal name for the printed ink drying methods given by the industry or academic society. However, for example, the types of commonly used methods for drying the printed ink are: oxidation polymerization drying type; infiltration dryness type; evaporation drying type; ultraviolet rays stiffening type; infrared rays stiffening type; electron beam stiffening type; normal temperature nature and dryness type; and thermal stiffening type mixed reaction type.

As the drying method, typically used is of the oxidation polymerization type, and the oxidation polymerization type drying method is used for drying the offset ink, typographic ink, and the like. With the oxidation polymerization type drying method, the printed ink is dried in the air by utilizing the oxygen contained in the air. The next most used drying method is the evaporation type drying method, which is used for drying the gravure ink, the rotary offset ink, and the like. The evaporation type drying method is a drying method with which ink is dried by being left in the air and by using heated air obtained from a gas burner, or the like. Further, there is a penetration type drying method targeting the rotary letterpress ink, the water-based flexo ink, and the like used as paper ink, and this drying method is a method with which the ink penetrates to the fiber of the paper, and dried in the air.

Recently, on-demand printing, which is “to print required number of copies as necessary”, has been attracting increasing attentions, and many on-demand printers are operating in Japan. For the on-demand printing, liquid type ink called “electol ink” is used.

It is necessary for the above-described various types of ink to be fixed on the print side by some kind of method after being transferred from a printing plate to a printed material. Fixation types (drying methods) vary depending on vehicle (printing varnish) composition of the printing ink. The fixation types (drying methods) for various types of printing ink will now be described in detail.

The evaporation drying method is a method which dries and solidifies the printing ink by evaporating a volatile solvent contained in the ink. Examples of such ink are quick-drying photogravure ink using a low boiling point solvent, flexo (printing varnish) ink, screen ink using a high boiling point solvent, pad ink, dry offset ink, and water-based ink. This evaporation drying method is a method that is the most effective and most employed method for fixing the printing ink on a plastic material on which infiltration dryness cannot be expected at all. The drying speed is adjusted according to the kinds of the solvent. At the same time, drying is accelerated by heat and hot air generated by a drying machine.

The oxidation polymerization type is a method which dries and solidifies the printing ink by absorbing the oxygen in the air onto the side printed with ink that includes drying oil as a main component and by connecting vehicle molecules with each other into netlike giant molecules. Examples of such printing ink are letterpress ink (excluding flexo ink), metal screen ink, and the like. This oxidation polymerization type requires a considerable amount of time, so that a metallic soap of manganese, cobalt, or the like is added as a dryer, and heat is applied thereon to accelerate drying.

The liquid reaction type is a method which uses one kind of ink out of two kinds having a resin containing reaction groups as a vehicle as ink and uses the other kind as a hardener so as to reaction-cure the printing ink with that combination. Example of such printing ink are polyurethane resin type gravure ink for retort pouches, screen ink having a resin of epoxy type, melamine type, or the like as a vehicle, pad ink, and the like. This liquid reaction type mixes the two kinds right before the use. Thus, after printing, reaction occurs following evaporation of the solvent, and the reaction is accelerated by applying heat. Reaction is advanced with the two-kind mixed ink without printing, so that there is an issue in terms of press stability. Normally, there are such issues that residual ink cannot be reused (pot life), for example, and it is necessary to be careful in handling. An ink film obtained by stiffening is strong, and the tolerance thereof is superb.

The ultraviolet (UV) rays stiffening type is a method which irradiates UV rays onto a printed ink film, and has it reacted instantly to be changed into a solidified film. Vehicles of UV ink are made with a polymer, a monomer, and a photopolymerization solvent (accelerator), and a photopolymerization initiator absorbs the UV rays of specific wavelength and triggers a chain reaction to cure the ink. Development of the UV rays stiffening type drying system has made it possible to overcome the issue of “drying characteristic” that is a major difficulty factor for employing offset printing, dry offset printing, and screen printing to plastics.

The infiltration dryness type is a method which is used in a case where a printing target is a piece of paper, with which the oil component in the ink penetrates into the paper and the solid component remains on the surface of the paper to be dried. Ink used for newspaper, for example, is a typical example of such printing ink. However, this is unsuitable for printing applied on print sides of non-absorbent plastics, metals, glass, and the like.

Most of printed materials, particularly magazines, contain a small amount of cornstarch powder base (maize starch) particles powder and paper dusts. Those particles powder are used to lighten generation of static electricity during a process of drying printing ink so as to avoid sticking of printed materials with each other, such as sticking of pages in magazines. In addition, an antioxdant is added to the cornstarch powder base. Further, it has been also pointed out that “blocking (offset)” may be less likely to occur when the cornstarch powder base is sprinkled over the whole surface of printed material. Since the cornstarch powder base is of microparticles powder, it also works to accelerate drying of the ink because the “air” enters from gaps in the ink.

In those on the market, it is clearly written that “antioxdant (sulfur dioxide)” is contained in all the ingredients. However, there is no clear explanation regarding why the antioxdant is used. Sulfur dioxide exhibits effects of inhibited oxidation and of bleaching. Sulfite, such as sub-sodium sulphide, is used as the material. The explanation often given is that cornstarch powder base is manufactured by employing a method which extracts starch after dipping cornstarch in sulfurous acid solution to have it resolved. This method is called a wet milling sub-sulfite acid soaking method.

### DISCLOSURE OF THE INVENTION

### Problems to be Solved by the Invention

As the printing ink fixing method described above, i.e., as the drying method, there are various methods described above. As the simplest method, however, the fixing method using the cornstarch powder base (maize starch) particles powder is employed.

However, since the cornstarch powder base particles powder are splashed over the whole printed material, it has been pointed out that this method deteriorates the printing work environments and the like. Therefore, there has been a demand for a low-cost printing ink drying method (fixing method) with a fine work environment, which can substitute such method.

Patent Document 1 discloses a technique which heats food to a preset temperature by using steam. Patent Document 2 only discloses a technique which cooks food materials by using superheated steam, and there is no indication about applying steam to the printing ink fixing method or about applying steam to avoid adhesion of printed materials with each other.

Moreover, there is no technical inquiry regarding the characteristic and property of steam in Patent Document 1 and Patent Document 2. In addition, there is no indication about applying steam to the printing ink fixing method or about applying steam to avoid adhesion of printed materials with each other.

Patent Document 1: Japanese Unexamined Patent Publication 2003-70644

Patent Document 2: Japanese Unexamined Patent Publication 2003-262338

An object of the present invention is to provide a printed material drying method and a printed material drying apparatus, which can achieve drying of printing ink by utilizing the Nano sized high-temperature dryness steam.

### Means for Solving the Problems

In order to achieve the foregoing object, the printed material drying method according to the present invention is a printed material drying method which performs drying processing on a printed material. The method includes: the Nano sized high-temperature dryness steam made as a cluster is generated to the Nano oder; jetting the Nano sized high-temperature dryness steam to a print side of the printed material; and imparting intramolecular vibrational energy to ink on the print side by the Nano sized high-temperature dryness steam.

The printed material drying apparatus for embodying the printed material drying method of the present invention is a printed material drying apparatus which performs drying processing on a printed material. The printed material drying apparatus includes: a steam generating device which generates high-temperature dryness steam; a cluster generating device which clusters the high-temperature dryness steam generated by the steam generating device on Nano oder; and an exciting device which jets the Nano sized high-temperature dryness steam generated by the cluster generating device to a print side of the printed material so as to impart intramolecular vibrational energy to ink on the print side by the Nano sized high-temperature dryness steam.

### EFFECTS OF THE INVENTION

The present invention makes it possible to dry printing ink and to avoid adhesion of printed materials with each other securely and easily by utilizing Nano sized high-temperature dryness steam.

### BEST MODES FOR CARRYING OUT THE INVENTION

Hereinafter, embodiments of the present invention will be described in detail by referring to the drawings.

FIG. 1 shows a printing device to which a printed material drying apparatus according to the embodiment of the present invention is applied. The printing device shown in FIG. 1 is a device which prints on a continuous rolled paper, and it is structured to: hold a printing paper 1a to a feeding roller 2; perform printing on a print side of the printing paper 1a fed out from the teeding roller 2 at a printing section 3; let already printed paper 1b go through the printed material drying apparatus A according to the embodiment of the present invention; and takes up dry-processed paper 1 onto a take-up roller 4.

As shown in FIG. 1, the printed material drying apparatus A according to the embodiment of the present invention is an apparatus which: accepts the printed paper 1b printed by the printing section 3 into inside a drying chamber 21; dries the ink on the printed material 1b quickly by Nano sized high-temperature dryness steam; and sends out the dried printed material 1b towards the take-up roller 4. As shown in FIG. 1-FIG. 3, the printed material drying apparatus A includes a steam generating device 5, a cluster generating device 6, and an exciting device 7.

The steam generating device 5 generates high-temperature dryness steam. Specifically, as shown in FIG. 3, the steam generating device 5 includes a boiler 8 and a water supply tank 9. Water is supplied to the water supply tank 9 via a water feed valve 10, and the water feed valve 10 is controlled by an upper-limit sensor 11 and a lower-limit sensor 12 to accumulate water W of a set amount inside the water supply tank 9. The water W is fed to the boiler 8 from the water supply tank 9 by a pump 13 through a nonreturn valve 14, and the boiler 8 includes a heater 15 for heating the supplied water. The boiler 8 heats the water by the heater 15 to generate high-temperature saturated steam M1. Reference numeral 16 is a sensor for detecting a water level within the boiler 8, 17 is a pressure relief valve for keeping the pressure within the boiler 8 to a specific pressure, and 18 is a feeding valve which takes out the high-temperature saturated steam M1 from the boiler 8. Further, on the output side of the boiler 8, a pipe 19 for letting through the high-temperature saturated steam M1 and a tubular heater 20 wound around the pipe 19 are provided. High-temperature dryness steam M2 is obtained by letting through the high-temperature saturated steam M1 within the pipe 19 that is heated by the tubular heater 20. Note that the boiler 8 and the water supply tank 9 of the steam generating device 5 are merely presented as a way of examples, and the structures thereof are not limited to those shown in the drawing. The steam generating device 5 may be a type other than the one shown in the drawing. The point is that the steam generating device 5 may be of any types, as long as it is in a structure capable of generating the high-temperature saturated steam M1.

The cluster generating device 6 and the exciting device 7 are placed inside the drying chamber 21 to which the already printed paper 1b is fed by a feeding roller 22. The cluster generating device 6 and the exciting device 7 will be described in detail. That is, pipes 23 and 24 are placed in a vertical direction by sandwiching the feeding roller 22 within the drying chamber 21 as shown in FIG. 1 and FIG. 2. As shown in FIG. 3, a plurality of nozzles 25 are opened in the pipes 23 and 24 towards the printed paper 1b that runs within the drying chamber 21. The cluster generating device 6 obtains Nano sized high-temperature dryness steam M3 made as a cluster is generated to the Nano oder through spraying the high-temperature dryness steam M2 from the nozzles 25 of the pipes 23 and 24 (see FIG. 2). The pipe 23 is placed on the print side of the printed paper 1b, and the pipe 24 is placed on the back face side of the printed material 1b. Distance R2 from the pipe 24 to the printing paper 1 is set to be shorter than distance R1 that is from the pipe 23 to the printing paper 1 (R1>R2). The distances from the pipes 23, 24 to the printed paper 1b are not limited to those illustrated in the drawing but may be changed as appropriate in accordance with the kind of the printed paper 1b. In FIG. 2, it is illustrated to spray the Nano sized high-temperature dryness steam M3 from a part of the pipe 23. However, it is sprayed from the whole length of the pipes 23 and 24.

As described above, the cluster generating device 6 utilizes the steam pressure within the boiler 8 to jet the high-temperature dryness steam M2 from the nozzles 25 of the pipes 23 and 24 so as to generate the Nano sized high-temperature dryness steam M3 that is obtained by Nano oder clustering performed on the high-temperature dryness steam M2 that is generated by the steam generating device 5.

Whether it is a hydrophilic pulp fiber or the printing paper 1 whose printing quality is being improved by applying pigments painting through improving the smoothness, whiteness, and opacity, there are apertures as shown in FIG. 4A and FIG. 4B, even though there are differences in size of the radiuses of the fiber pores (capillaries). The cluster generating device 6 jets out the high-temperature dryness steam M2 from the nozzles 25 of the pipes 23 and 24 to generate the Nano sized high-temperature dryness steam M3 having the size of several molecules to several tens of molecules in accordance with the property of the printed paper 1b described above. For the cluster generating device 6 to generate the Nano sized high-temperature dryness steam M3 on the order of several molecules to several tens of molecules, the cluster generating device 6 employs a method which adjusts the diameter of the nozzles 25 opened in the pipe 23 or a method which adjusts the steam pressure of the boiler 8 to generate the Nano sized high-temperature dryness steam M3 according to the fiber pores of the printing paper 1, for example.

The inventors of the present invention has analyzed the fiber pores of the printing paper 1 and found that it is most idealistic to set the high-temperature dryness steam M2 to be in a size within a range of several molecules to several tens of molecules in order to let through the Nano sized high-temperature dryness steam M3 to the fiber pores of generally-used printing paper 1. The particle diameter of the Nano sized high-temperature dryness steam M3 obtained by performing Nano oder clustering on the high-temperature dryness steam M2 was calculated by using a theoretical formula. The high-temperature dryness steam M3 of 150-210° C. was sprayed onto the printing paper 1, and the particle diameter of the Nano sized high-temperature dryness steam M3 that can keep the moisture content of the printed paper 1b required in the industry of printing within a range of 8.5-7.5% was specified within a range of several molecules to several tens of molecules by using a paper moisture meter K-200 Manufacturer: KETT). There are various properties of printed papers 1b, particularly those with different fiber pore diameters, so that it is impossible to specify the lower limit number of molecules of the cluster to a specific numerical value. Thus, the lowest cluster molecule number was set as roughly less than 9, i.e., set as several molecules on calculations. This was set as the lower limit range of the number of cluster molecules. Similarly, it is impossible to specify the upper limit number of molecules of the cluster to a specific numerical value. Thus, it was verified that the highest cluster molecule number was about 10-90 molecules i.e., verified as several tens of molecules on calculations. This was set as the upper limit range of the number of cluster molecules.

Based on the above-mentioned consideration, the cluster of the Nano sized high-temperature dryness steam M3 generated by the cluster generating device 6 was specified to be within the range of several molecules to several tens of molecules. The above studies were done based on the printing paper that are currently on the market, so that it is expected that the number of molecules of the cluster of the Nano sized high-temperature dryness steam M3 fluctuates depending on the property of the printing papers that are to be developed in the future. The point is that the number of molecules of the cluster of the Nano sized high-temperature dryness steam M3 generated by the cluster generating device 6 may take any values as long as it is the value with which the Nano sized high-temperature dryness steam M3 can pass through the fiber pores of the printing paper and can impart intramolecular energy to the ink on the printing paper by the exciting device 7 to be described later.

The exciting device 7 utilizes the steam pressure within the boiler 8 and jets it out from nozzles 25 of the pipe 23 to spray the high-temperature dryness steam M3 made as a cluster is generated to the Nano oder onto the print side of the printed paper 1b to give the intramolecular energy to the ink 26 of the printed paper 1b by the high-temperature dryness steam M3 (see FIG. 5A).

Specifically, the exciting device 7 has the Nano sized high-temperature dryness steam M3 made as a cluster is generated to the Nano oder of several molecules to several tens of molecules generated by the cluster generating device 6 pass through the fiber pores of the printed paper 1b, and has the Nano sized high-temperature dryness steam M3 collide with the ink 26 on the print side to impart the intramolecular energy to the ink 26 (see FIG. 5A).

Ink includes polar molecules. The polar molecule means an electric dipole whose oxygen side has a minus charge and hydrogen side has a plus charge, for example. Since the ink has polar molecules, it has such a property that notable temperature increase can be obtained when an energy is applied from outside compared to a case of having nonpolar molecules.

Unlike the normal water molecule cluster, the Nano sized high-temperature dryness steam M3 clustered by the cluster generating device 6 is in a high temperature and in a dry state. Thus, it is in a state of a high energy (excited state).

Therefore, when the exciting device 7 has the Nano sized high-temperature dryness steam M3 collide with the ink 26 on the print side, the thermal influence of the Nano sized high-temperature dryness steam M3 comes to give an energy as intramolecular vibration 26a to the inside the ink of the print side (see FIG. 5A).

Next, described is a method for drying (fixing) the ink attached on the print side of the printed paper 1b by using the printed material drying apparatus A according to the embodiment of the present invention.

First, the steam generating device 5 heats the water with the heater 15 of the boiler 8 to generate the high-temperature saturated steam M1 within the boiler 8. When the feeding valve 18 is opened, the steam generating device 5 sends out the high-temperature saturated steam M1 within the boiler 8 to the pipe 19 by the steam pressure within the boiler 8. The pipe 19 is heated by the tubular heater 20, so that the steam supplied from the pipe 19 becomes the high-temperature dryness steam M2.

When the high-temperature dryness steam M2 is supplied to the pipes 23 and 24 from the steam generating device 5, the cluster generating device 6 sprays the high-temperature dryness steam M2 towards the printed paper 1b from the pipes 23, 24 by utilizing the steam pressure within the boiler 8 so as to generate the Nano sized high-temperature dryness steam M3 made as a cluster is generated to the Nano oder.

The exciting device 7 utilizes the steam pressure within the boiler 8 and jets out the Nano sized high-temperature dryness steam generated by the cluster generating device 6 onto the print side of the printed paper 1b to impart the intramolecular energy to the ink on the print side by the Nano sized high-temperature dryness steam. Specifically, the exciting device 7 sprays the Nano sized high-temperature dryness steam M3 to the printed paper 1b to have the Nano sized high-temperature dryness steam M3 pass through the fiber pores of the printed paper 1b and to have the Nano sized high-temperature dryness steam M3 collide with the ink 26 on the print side to impart the thermally excited energy of the Nano sized high-temperature dryness steam M3 as the intramolecular energy 26a of the ink 26. Next, the principle of drying (fixing) the ink on the print side by the Nano sized high-temperature dryness steam M3 will be described.

Conventional ink drying uses hot air of about 200° C., so that bubbles are generated in the ink. The reason thereof will be described. As shown in FIG. 5B, only the surface of the ink 26 is dried by receiving the thermal influence of the hot air, so that a surface stiffening film 26b is formed on the surface of the ink 26. Further, when heating is progressed, the heat is transferred (heat conduction) inside the ink 26 and non-dried regions are bumped up locally, thereby generating bubbles 26c. In order to avoid this, it is necessary to perform drying of the ink 26 by reducing the heat capacity and securing the heating time more than it is necessary in order to equalize the heat conduction after the surface stiffening film 26b is formed. Thus, it is not possible to shorten the drying time of the ink.

The embodiment of the present invention is designed to accelerate drying of the ink effectively by using the Nano sized high-temperature dryness steam. The mechanism thereof is as follows.

(1) As described above, the Nano sized high-temperature dryness steam (ultra-fine water drop cluster) is formed with clustered particles on the order of several molecules to several tens of molecules, and is formed with high-temperature particles of 150-210° C.
(2) The printing paper as the heating target is made mainly with paper, ink (water-based, pigments, and aliphatic carbonization water-solvent such as toluene, xylene, benzene, and the like), and a coating (pigments paint) material.
(3) Even though there are various kinds as the structure of the printed papers, the printed papers basically have a pore (gap) structure in which structural fibers are laminated. Thus, the printing papers include many apertures microscopically as shown in FIG. 4A and FIG. 4B.

When the exciting device 7 sprays the Nano sized high-temperature dryness steam M3 clustered on the Nano oder to the printed paper 1b, the Nano sized high-temperature dryness steam M3 passes through the fiber pores of the printed paper 1b. This is because the clustered molecules of the Nano sized high-temperature dryness steam M3 are set to be in a size capable of passing through the fiber pores by considering the diameter of the fiber pores of the printed paper 1b. Therefore, the Nano sized high-temperature dryness steam M3 that is the particles of the order of several molecules to several tens of molecules easily passes through the fiber pores of the printed paper 1b, so that the Nano sized high-temperature dryness steam M3 does not contribute to heating the printing paper 1b. As a result, the printing paper can maintain the moisture content that is required in the printing industry.

Further, when the exciting device 7 jets the Nano sized high-temperature dryness steam M3 clustered on the Nano oder to the printed paper 1b, the Nano sized high-temperature dryness steam M3 collides with the ink 26 that is attached on the print side of the printed paper 1b as shown in FIG. 5A.

Unlike the normal water molecule cluster, the Nano sized high-temperature dryness steam M3 clustered by the cluster generating device 6 is in a high temperature and in a dry state, so that it is in a state of a high energy (excited state).

Therefore, when the exciting device 7 has the Nano sized high-temperature dryness steam M3 collide with the ink 26 on the print side, the thermal influence of the Nano sized high-temperature dryness steam M3 comes to impart the energy as the intramolecular vibration 26a to the inside the ink 26 of the print side as shown in FIG. 5A. Upon receiving the energy from the Nano sized high-temperature dryness steam M3, vibration of the water molecules inside the ink 26 becomes more intense. Thus, the temperature within the ink is increased due to generation of frictional heat. According to this principle, drying of the ink 26 is accelerated.

With the above-described mechanism, when drying the ink on the printing paper, the printed paper 1b is not heated but only the ink 26 thereon absorbs the energy of the Nano sized high-temperature dryness steam, and generates heat and causes evaporation. This makes it possible to heat only the ink selectively.

When drying the ink on the printing paper, the Nano sized high-temperature dryness steam M3 at least easily passes through the inside the pores (capillaries) of the printing paper by using the water molecules clustered on the Nano oder (high-temperature dryness steam cluster on the order of several molecules to several tens of molecules). Thus, only the ink absorbs the energy of the Nano sized high-temperature dryness steam without heating the printing paper, and generates heat and causes evaporation. Thereby, only the ink can be heated selectively.

FIG. 6 shows schematic charts of drying degree−time passage, showing influence of the Nano sized high-temperature dryness steam on drying the ink. FIG. 6b is the chart of drying degree−time passage according to the conventional ink drying, with which a lot of time hangs at dry time (t₁−t₂), and the quality of dryness (D₁) is also poor.

In the meantime, FIG. 6A is the chart of drying degree−time passage according to the ink drying achieved by the Nano sized high-temperature dryness steam of the embodiment of the present invention, with which the time required for drying is almost instantaneous (tₐ−t_{b}), and the quality of dryness (D₂) is also excellent. This is because the conventional ink drying method as described above dries the ink in a following manner. That is, the surface layer of the ink is dried by receiving the thermal influence→the surface stiffening film is formed→bubbles are generated→heat is transferred into inside the ink. In the meantime, with the Nano sized high-temperature dryness steam, heat is generated inside the ink and the ink is dried with the conductive heat. Therefore, high-quality drying can be accelerated.

In the above, drying of the ink 26 on the printing paper 1b by using the Nano sized high-temperature dryness steam M3 has been specifically described. However, the present invention is not limited only to that. That is, the printed material drying apparatus A according to the embodiment of the present invention can accelerate the deodorizing effect of a noxious gas 26d (drying-oil component=unsaturated fatty acid, oil-based solvent, etc.) generated in the process of drying the ink 26. Specifically, as shown in FIG. 5A, the noxious gas 26d contained in the component of the ink 26 is generated in the process of drying the ink 26. The noxious gas 26d may give off a nasty smell. This noxious gas 26d is mainly generated in the process where the printed material 1b travels inside the drying chamber 21. More specifically, the noxious gas 26d may be emitted from the drying chamber 21 to the outside in following processes.

(1) In the process where the low boiling point solvent of the ink is evaporated and dried.
(2) In the process where: oxygen in the air and the drying-oil component (unsaturated fatty acid) in the ink are combined by a catalysis caused by a dryer; a chemical change occurs; polymerization of the drying oil occurs; and the ink is dried.
(3) In the process where the oil-based solvent in the ink is evaporated and dried by the heat.

When the noxious gas 26d leaks to the work environment outside the drying chamber 21, not only the work environment is contaminated but also the residents in the surroundings of the printing factory is exposed to bad influences.

With the embodiment of the present invention, the Nano sized high-temperature dryness steam M3 is jetted out from the pipes 23, 24 to form an air curtain within the drying chamber 21. In a space sectioned by the air curtain, the Nano sized high-temperature dryness steam M3 in ultra-fine particles by being clustered on the Nano oder collides with the noxious gas 26d that is generated from the ink 26. When the Nano sized high-temperature dryness steam M3 on the Nano oder collides with the noxious gas 26d (clustered water drops tend to become negative ions, and the noxious gas 26d is attached thereto), the noxious gas 26d is ion-decomposed by the Nano sized high-temperature dryness steam M3. It is taken into the cluster droplets, and collected to a saucer (reference numeral B in FIG. 1) for the cluster droplets.

As described above, the embodiment of the present invention can achieve drying of the printing ink by utilizing the Nano sized high-temperature dryness steam.

Further, by having the Nano sized high-temperature dryness steam pass through the fiber pores of the printing paper through setting the cluster molecules of the Nano sized high-temperature dryness steam to be within a range of several molecules to several tens of molecules, it is possible to dry the ink while maintaining the moisture content of the printing paper required in the printing industry by avoiding to heat the printing paper.

Furthermore, it is possible to heat only the ink on the print side selectively with the Nano sized high-temperature dryness steam. Moreover, the intramolecular vibration is generated inside the ink, so that drying of the ink can be accelerated.

Further, the embodiment of the present invention makes it possible to keep the clean work environment without having the noxious gas generated from the ink leak to the work environment due to the combined effect of the chemical bonding of the noxious gas generated during the ink drying process with negative ions generated by Lenard effect with which a droplet is ionized in the nearby air when it is dissolved (i.e., deodorizing effect by the oxidation reaction generated by the collision with the Nano sized high-temperature dryness steam) and the effect of taking the noxious gas into the cluster droplets. Further, even when printing is performed in environments where factories and residential areas are close, the embodiment makes it possible to avoid contamination of the environment without obstructing the health of the nearby residents by leaking no noxious gas to the surroundings of the printing factory. As described, the embodiment can provide the ink drying processing that is also good for the environments.

Next, an investigation was conducted in order to dry the ink by using the printed material drying apparatus according to the embodiment of the present invention. There has not been any thesis which academically analyzes the most important factors for enabling drying of the printing ink by utilizing the Nano sized high-temperature dryness steam. The inventors of the present invention conducted studies and experiments, and came to a conclusion that the most important factors for performing drying of the printing ink are the high-temperature dryness temperature and the moisture content on the print side of the printing paper.

Normally, it is considered in the printing industry that the moisture content of the printing paper to which printing has been done is in a range of 8.5-4.5%. In a case of performing drying by using hot air, the moisture content of the printing paper is decreased. In that case, following issues occur: (1) generation of static electricity; (2) contraction (distortion) of the paper surface; (3) swelling (expansion) of the paper surface; and (4) deterioration in the bending strength.

The inventors of the present invention have come to a conclusion that the use of Nano sized high-temperature drying air can make it possible to dry the ink without decreasing the moisture content. Hereinafter, details thereof will be described in details.

A: Relation between Paper Basis Weight and Moisture Content

In the experiment, paper basis weights of 180 g/m² and 240 g/m² were used as cut sheet (single paper). FIG. 7 shows the relation between the paper surface temperature and the moisture content in a case where the cut sheet is let through the ink high-temperature dryer after printing offset ink (off rotary ink) on the surface.

A paper moisture meter K-200 (Manufacturer: KETT) was used for measuring the moisture content of the printing paper. A pocket radiometer PC-8400 (Manufacturer: SATO KEIRYOKI MFG. Co., LTD) was used for measuring the paper surface temperature. The sensor was of a thermopile type, and the measurable range was −60-240° C. The measurement distance between the paper surface and the sensor was fixed to be about 30 mm.

As the result of the experiment, it was found that the surface temperature is higher with the paper having the smaller basis weight 180 g/m² (thin cut sheet) than that of the paper with the larger basis weight 240 g/m² (thick cut sheet). Further, there is a tendency that the moisture content of the basis weight becomes lower as the paper surface temperature becomes higher. This is simply considered because the heat can be absorbed quickly with the paper having the small basis weight (thinner paper). This can be lead to the fact that the heat absorption and heat radiation can be done more quickly when the paper is of the smaller basis weight. Thereafter, the experiment was conducted by using the paper having the basis weight of 180 g/m² by considering the printing on a rolled paper.

### B: In-Chamber Temperature of Drying Chamber 21 and Moisture Content of Printed Paper 1b

FIG. 8 shows the relation between the in-chamber temperature and the moisture content of the paper surface. In FIG. 8, the lateral axis shows the in-chamber temperature. The temperature was set within a range of 180-210° C., and measurement was conducted at 10° C. interval. The longitudinal axis shows the moisture content on the printing paper surface measured at each temperature. The in-chamber temperature means the temperature of the Nano sized high-temperature dryness steam within the drying chamber. It was found as a result that a large difference in drying of the ink by using the Nano sized high-temperature drying steam is that the paper surface temperature is not increased, so that contraction and swelling of the paper surface mentioned above were not observed. This is in common to the case with a printing paper feeding speed of 1.8 m/min and a faster feeding speed of 3.6 m/min (180-360 cm/min).

From this experiment, it was found that the feeding speed of 3-3.6 m/min of the printing paper 1b within the drying chamber 21 and the in-chamber temperature of about 180-190° C. were the optimum in a case where the required printing paper moisture content is in a range of 8.5-7.5%.

### C: In-Chamber Temperature of Drying Chamber 21 and Surface Temperature of Printed Paper 1b

FIG. 9 shows the relation between the in-chamber temperature and the paper surface temperature. The in-chamber temperature was changed in a range of 180-210° C. From FIG. 8, it has already been found that the optimum in-chamber temperature was about 180-190° C. From FIG. 9, the paper surface temperature when the in-chamber temperature was 180-190° C. was about 70-90° C. Since the paper surface temperature varies according to the paper basis weight, those temperatures do not correspond to all the cases. However, those are considered as adequate numerical values for the case with the water basis weight of 180 g/m², and 1.8-3.6 m/min.

In the meantime, the paper surface temperature increases as the in-chamber temperature becomes higher. Further, there is obviously a tendency that the slower the feeding speed is, the higher the paper surface temperature becomes. Therefore, for enabling an operation with an increased in-chamber temperature, the target paper surface temperature can be obtained by increasing the paper feeding speed.

D: Feeding Speed of Printed Paper 1b within Drying Chamber 21 and Paper Surface Temperature

FIG. 9 and FIG. 10 show the relation between the paper surface speed and the paper surface temperature. In order to secure the feeding speed 1.8-3.6 m/min of the printed paper 1b and the paper surface temperature of 70-90° C., the in-chamber temperature of 180-190° C. is the optimum. It is also clear from FIG. 9 and FIG. 10 that the paper surface temperature tends to increase as the in-chamber temperature becomes higher.

### E: Surface Temperature and Moisture Content of Printing Paper

FIG. 11 shows the relation between the surface temperature of the printing paper and the moisture content of the paper surface. In order to keep the moisture content of the printing paper around 7.5-9%, it is important to set the surface temperature of the printing paper to be in a range of 70-90° C. and to the feeding speed of 3-3.6 m/min.

Inversely, the result thereof indicates that it is an important factor to set the feeding speed as 3.6 m/min or more in order to have the moisture content of the printing paper to be in a range of 9-10%.

### F: Feeding Speed of Printing Paper and Moisture Content

FIG. 12 shows the relation between the feeding speed and the moisture content of the paper surface. As in the case of FIG. 11, it is important to set the feeding speed as 3-3.6 m/min and to set the in-chamber temperature as 180-190° C. in order to suppress the moisture content of the printing paper to 7-9%.

That is, when the in-chamber temperature is increased, the moisture content of the printing paper becomes decreased. Thus, it is important to control the in-chamber temperature.

G: Paper Surface Temperature of Printing Paper Affected by Distance between Printing Paper and Nozzle 25 of Pipe 23 Placed above Printing Paper

In order to investigate the paper surface temperature affected by the distance between the nozzle 25 and the printed paper 1b, the nozzle height from the paper surface is plotted on the lateral axis. The height of the nozzle 25 from the paper surface of the printed paper 1b was set to a range of 25-65 mm. The longitudinal axis shows the surface temperature or the moisture content of the printing paper surface measured at each temperature. FIG. 13 shows the influence on the paper surface temperature affected by the distance between the nozzle and the paper surface.

When the distance between the nozzle and the paper surface was brought closer to be 25 mm, the surface temperature of the paper was increased. Inversely, when the distance is set away to be 65 mm, there was a tendency of reduction in the surface temperature of the paper. This is considered because the dryness steam temperature is higher when the paper surface is closer to the nozzle, so that the printing paper is exposed to high temperatures.

In the meantime, as shown in FIG. 14, the moisture content tends to increase. This is intimately related to the temperature of the Nano sized high-temperature dryness steam shown in FIG. 13, and it indicates that the moisturized printing can be done by keeping a specific distance between the nozzle and the paper surface.

H: Ink Attaching Degree Affected by In-Chamber Temperature of Drying Chamber 21 and Feeding Speed of Printing Paper

In order to perform quantitative evaluation of the drying degree of the ink, “tape putting method” was employed. With this method, the area ratio of the ink residual was obtained by image processing through a following procedure.

(1) Cellophane adhesive tape was put on the print side.
(2) Scanning was conducted from 600 dpi by using a scanner function of a copying machine (RICOH imagio Neo c285).
(3) Trimming processing was conducted by adobe photoshop 6 to perform binarization with a threshold value 255.
(4) Thereafter, the area ratio was obtained by using image software.

FIG. 15 shows examples of the in-chamber temperatures and the ink attaching degrees (average). Simply, when there are more black dots, it means that the ink is un-dried. Thus, black dots (ink) are transferred to the cellophane adhesive tape side.

FIG. 16 shows the relation between the in-chamber temperature and area ratio obtained from the ink attaching degree (binarized by the image processing) by using the tape putting method, and FIG. 17 shows the relation between the ink attaching degree and the feeding speed.

From the results of those, it was found that the proper temperature for achieving low ink attaching degree was 200° C. For the feeding speed of the printing paper, the ink attaching degree was low and excellent performance was observed at the lowest speed of 2.4-3.0 m/min.

The reason the ink attaching degree was worsened with the 210° C. high-temperature dryness steam was that a bumping phenomenon occurred in the rotary ink when the temperature thereof exceeds 200° C. Thus, in normal printing, it is cooled down by a cooling cylinder to accelerate solidification (fixation) of the ink. However, the case of the apparatus of the present invention did not use the cooling cylinder, so that it is considered that ink was fluidized in that case.

As evident from the results of the above-described experiments, it has been proved that acceleration of drying the ink on the printing paper by using the Nano sized high-temperature dryness steam clustered on the Nano oder as in the embodiment of the present invention is fully practical.

### INDUSTRIAL APPLICABILITY

The present invention is capable of drying the ink of the printed material by using the Nano sized high-temperature dryness steam while keeping the moisture retention in the printing paper.

### BRIEF DESCRIPTION OF THE DRAWINGS

FIG. 1 is a block diagram showing an example of a printing device to which a printed material drying apparatus according to an embodiment of the present invention is applied;

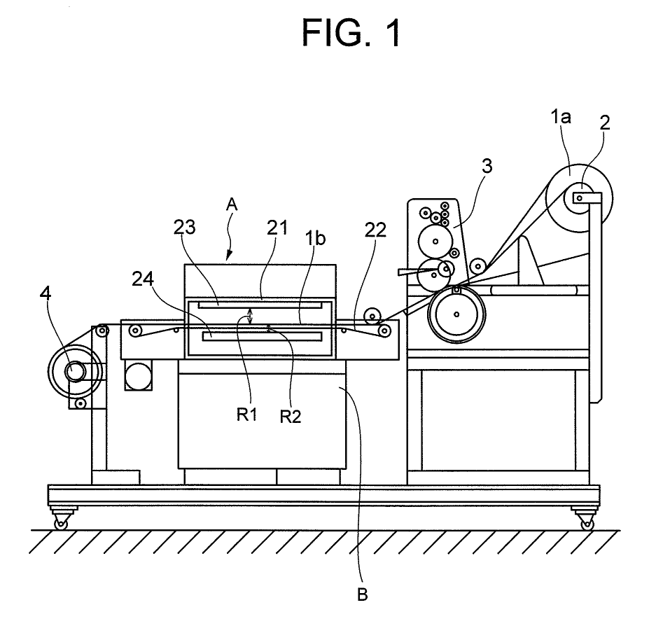

FIG. 2 is a perspective view showing a cluster generating device and an exciting device in the printed material drying apparatus according to the embodiment of the present invention;

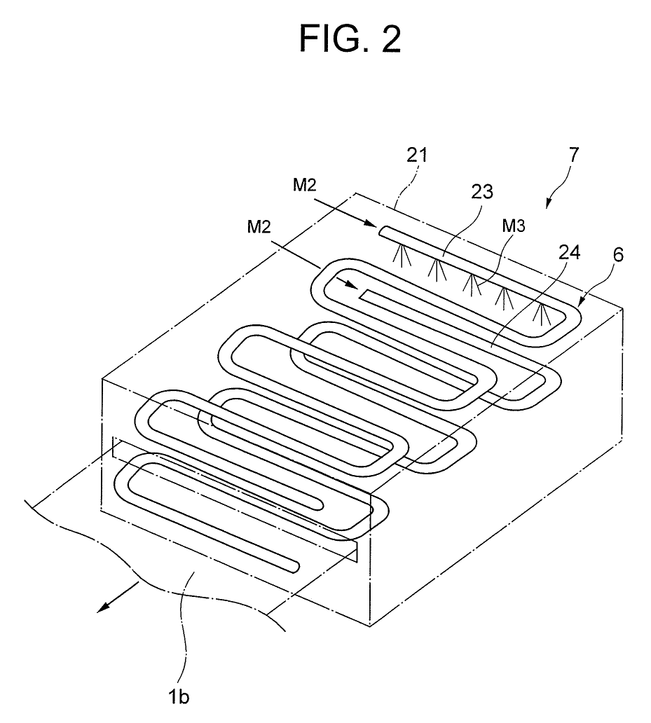

FIG. 3 is an illustration showing the relation regarding a steam generating device, the cluster generating device, and the exciting device in the printed material drying apparatus according to the embodiment of the present invention;

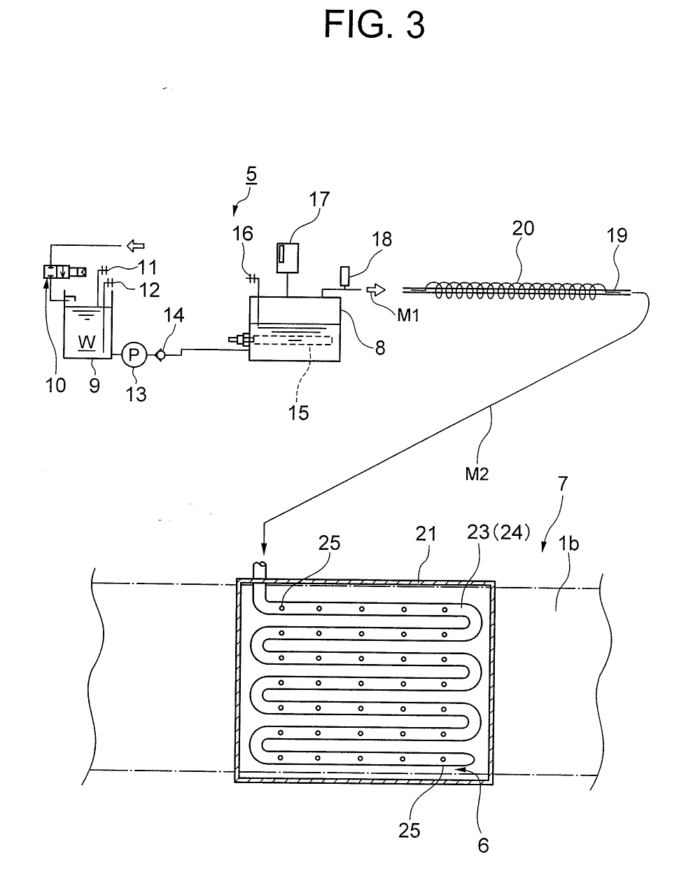

FIG. 4 shows photographs of fiber pores of a printing paper observed by a scanning electron microscope;

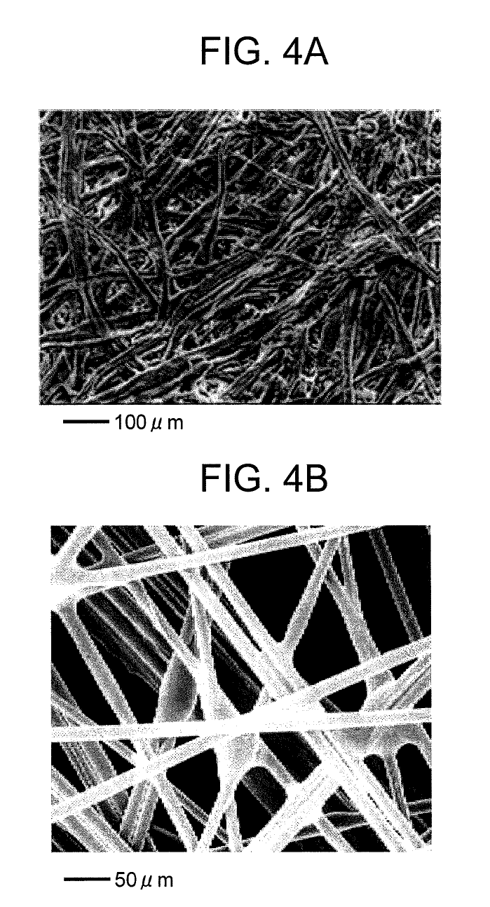

FIG. 5A is an illustration showing the principle of drying the ink by the printed material drying apparatus according to the embodiment of the present invention, and FIG. 5B is an illustration showing the principle of drying the ink according to a conventional case;

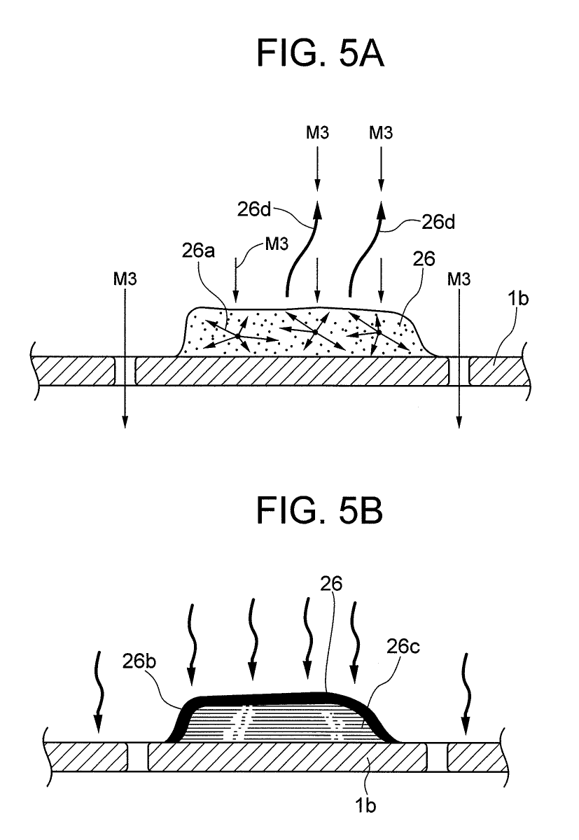

FIG. 6A is a characteristic chart showing the ink drying degree achieved by the printed material drying apparatus according to the embodiment of the present invention, and FIG. 6B is a characteristic chart showing the ink drying degree of a ink drying method according to the conventional case;

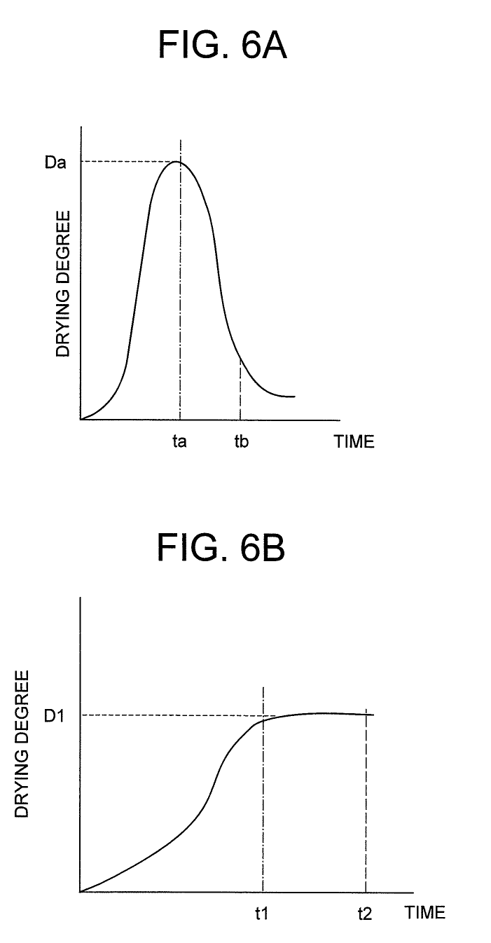

FIG. 7 is a chart showing the surface temperature and the moisture content of a printing paper in a cut sheet;

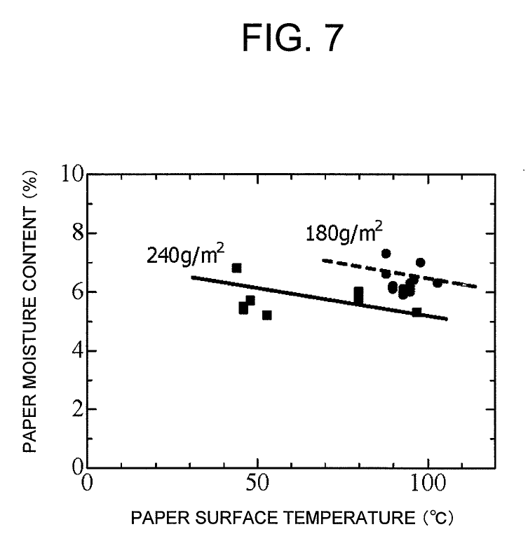

FIG. 8 is a chart showing the relation between the in-chamber set temperature and the moisture content of the printing paper in a cut sheet;

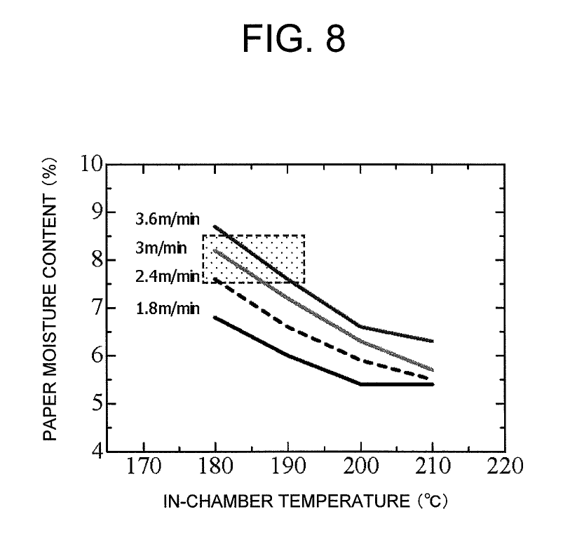

FIG. 9 is a chart showing the relation between the in-chamber set temperature and the paper surface temperature of the printing paper in a cut sheet;

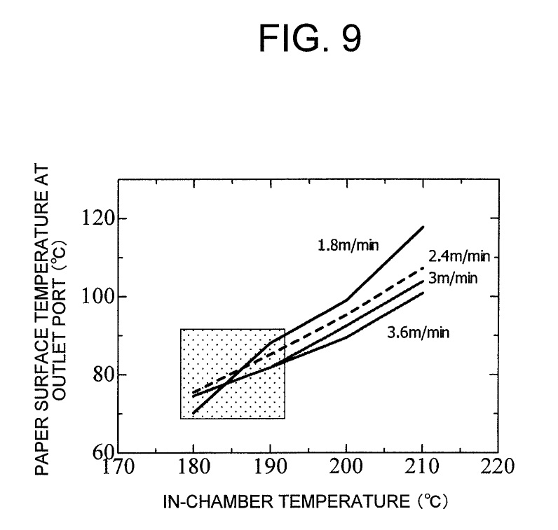

FIG. 10 is a chart showing the relation between the feeding speed of the printing paper and the paper surface temperature of the printing paper in a cut sheet;

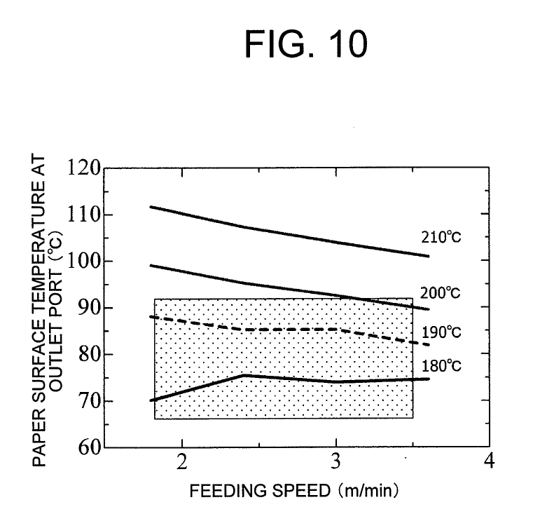

FIG. 11 is a chart showing the relation between the paper surface temperature and the moisture content of the printing paper in a cut sheet;

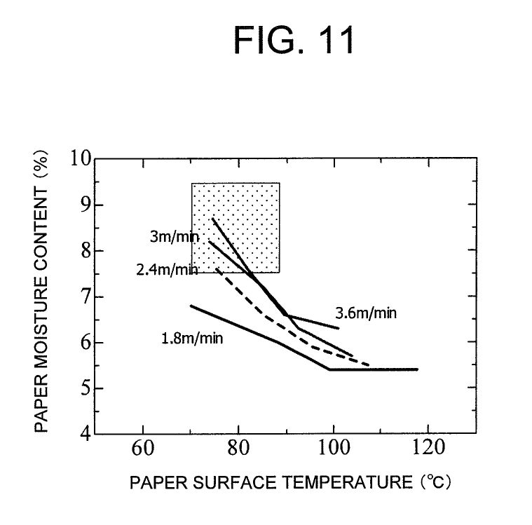

FIG. 12 is a chart showing the relation between the feeding speed of the printing paper and the moisture content of a printing paper in a cut sheet;

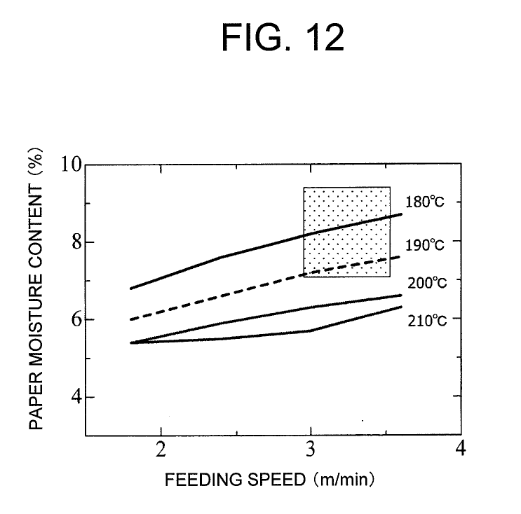

FIG. 13 is a chart showing the surface temperature of the printing paper affected by the distance between a nozzle and the printing paper;

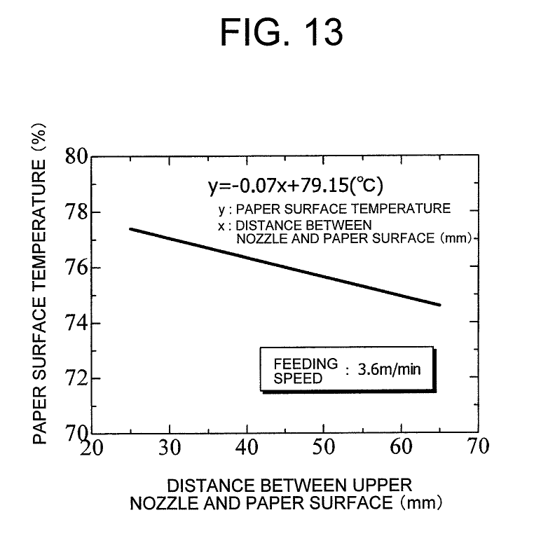

FIG. 14 is a chart showing the moisture content of the printing paper affected by the distance between the nozzle and the printing paper;

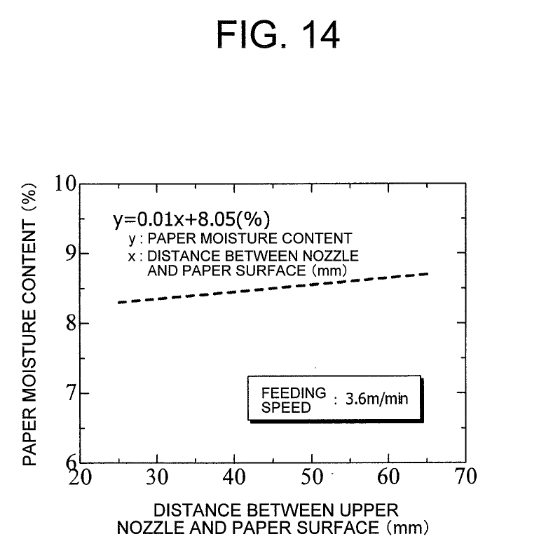

FIG. 15 is an illustration showing the ink attaching degree when using an adhesive tape putting method;

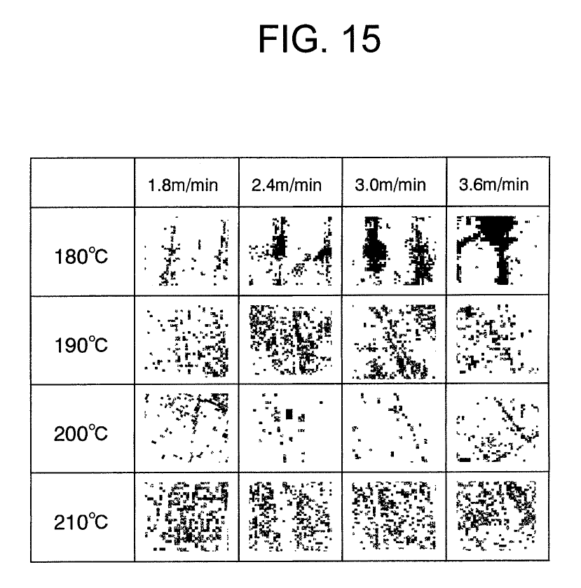

FIG. 16 is a chart showing the relation between the in-chamber temperature and the ink attaching degree of the printing paper in a cut sheet; and

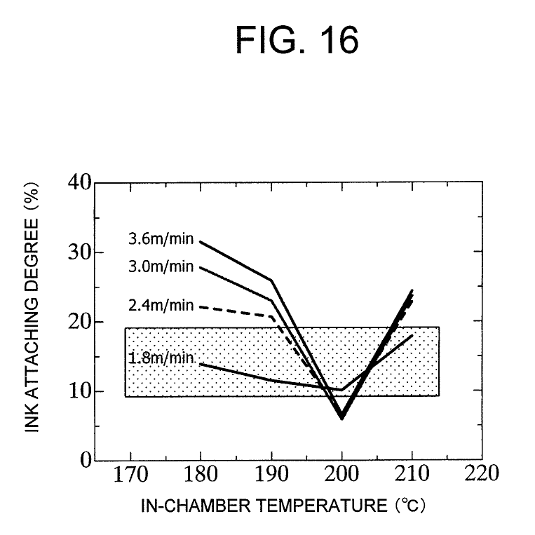

FIG. 17 is a chart showing the relation between the feeding speed of the printing paper and the ink attaching degree of the printing paper in a cut sheet.

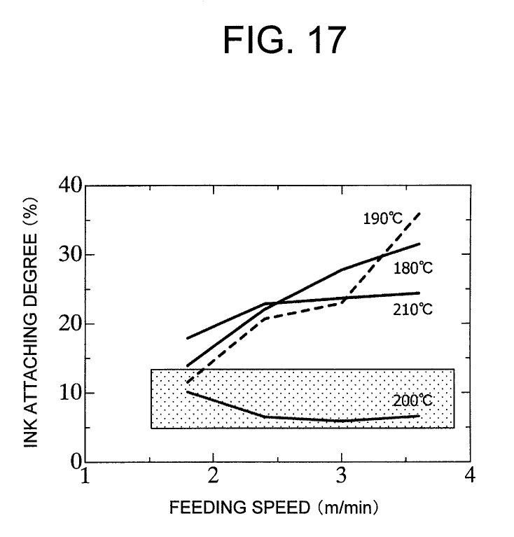

### REFERENCE NUMERALS

5 Steam generating device
6 Cluster generating device
7 Exciting device

1. A printed material drying method which performs drying processing on a printed material, the method comprising:
generating Nano sized high-temperature dryness steam in an excited state through jetting high-temperature dryness steam from a nozzle to perform Nano order clustering;
jetting the Nano sized high-temperature dryness steam to a print side of the printed material; and
having a part of the clustered Nano order high-temperature dryness steam pass through fiber pores of the printed material, and having remainder of the Nano sized high-temperature dryness steam collide with ink on the print side so as to excite intramolecular vibration to the ink on the print side by energy of the excited Nano sized high-temperature dryness steam.

2. The printed material drying method as claimed in claim 1, wherein the Nano sized high-temperature dryness steam is clustered on the Nano order of several molecules to several tens of molecules which can pass through fiber pores of the printed material.

3. The printed material drying method as claimed in claim 2, wherein the Nano sized high-temperature dryness steam is clustered on the Nano order of several molecules to several tens of molecules so as to have the Nano sized high-temperature dryness steam pass through the fiber pores of the printed material and to have the Nano sized high-temperature dryness steam collide with the ink on the print side.

4. The printed material drying method as claimed in claim 3, wherein the Nano sized high-temperature dryness steam is collided with the ink on the print side to impart thermally excited energy of the Nano sized high-temperature dryness steam to the ink having polar molecules as intramolecular vibrational energy.

5. The printed material drying method as claimed in claim 1, wherein the Nano sized high-temperature dryness steam is jetted to both sides of the printed material.

6. A printed material drying apparatus which performs drying processing on a printed material, comprising:
a steam generating device which generates high-temperature dryness steam;
a cluster generating device which generates dried Nano sized high-temperature dryness steam in an excited state through jetting the high-temperature dryness steam generated by the steam generating device from a nozzle to perform Nano order clustering; and
an exciting device which jets the Nano sized high-temperature dryness steam generated by the cluster generating device to a print side of the printed material, has a part of the clustered Nano oder high-temperature dryness steam pass through fiber pores of the printed material, and has remainder of the Nano sized high-temperature dryness steam collide with ink on the print side so as to excite intramolecular vibration to the ink on the print side by energy of the excited Nano sized high-temperature dryness steam.

7. The printed material drying apparatus as claimed in claim 6, wherein the cluster generating device clusters the high-temperature dryness steam on the Nano order of several molecules to several tens of molecules which can pass through fiber pores of the printed material.

8. The printed material drying apparatus as claimed in claim 6, wherein the exciting device has the Nano order high-temperature dryness steam that is clustered on the Nano order of several molecules to several tens of molecules pass through the fiber pores of the printed material and has the Nano sized high-temperature dryness steam collide with the ink on the print side.

9. The printed material drying apparatus as claimed in claim 8, wherein the exciting device has the Nano sized high-temperature dryness steam collide with the ink on the print side so as to impart thermally excited energy of the Nano sized high-temperature dryness steam to the ink having polar molecules as the intramolecular vibrational energy.

10. The printed material drying apparatus as claimed in claim 6, wherein the exciting device jets the Nano sized high-temperature dryness steam to both sides of the printed material.
